(19) United States
(12) Patent Application Publication
(10) Pub. No.: US 2026/0328095 A1
(43) Pub. Date: Oct. 22, 2026

(54) ROTOR DEVICE FOR A FLOW MACHINE, ROTOR DISK AND DAMPING ELEMENT

(71) Applicant: MTU Aero Engines AG, Munich (DE)

(72) Inventors: Andreas HARTUNG, Munich (DE); Markus SCHLEMMER, Munich (DE); Adam KOSCSO, Munich (DE); Daniel THEURICH, Munich (DE)

(21) Appl. No.: 19/649,162

(22) Filed: Apr. 16, 2026

(30) Foreign Application Priority Data
Apr. 17, 2025 (DE) 102025115322.1

(51) Int. Cl. F01D 5/10; F04D 19/00; F04D 29/32; F04D 29/66

(52) U.S. Cl. CPC F01D 5/10; F04D 19/00; F04D 29/321; F04D 29/668; F05D 2260/36; F05D 2260/96

(57) ABSTRACT

A rotor device for a flow machine, including a rotor disk, wherein the rotor disk includes at its outer circumference a blade platform ring on which a blade ring is arranged, and a damper. A flange arrangement, which extends in the circumferential direction, projects from a radially inner surface of the blade platform ring, forms a flange angle with the radially inner surface of the blade platform ring and has at least one passage opening. The damper has at least one damping element. The damping element has at least one holding part. A contact section of the holding part bears against the inner surface of the blade platform ring and a pass-through section of the holding part passes through the at least one passage opening of the flange arrangement.

### CROSS REFERENCE TO RELATED APPLICATIONS

This application claims benefit to German Patent Application No. DE 10 2025 115 322.1, filed on Apr. 17, 2025, which is hereby incorporated by reference herein.

### FIELD

The invention relates to a rotor device for a flow machine, to a rotor disk, and to a damping element.

### BACKGROUND

In rotor stages for flow machines, vibrations can occur during operation due to mechanical and aerodynamic effects. The vibrations result in a dynamic loading of the components, which can lead to vibration fractures. High-frequency oscillations in the range of fatigue strength (HCF) are particularly relevant here. In individual blades of a blade ring, both bending and torsional vibrations can form. When the blades are connected to a rotor disk or a rotor ring by means of a dovetail connection, friction-induced damping of the vibrations occurs at the connections. If the rotor disk and the blade ring are arranged in a blisk design, they are connected to one another in an integrated manner. This damping is eliminated in the integrated connection. As a result, integrated components are particularly endangered by vibrations.

In order to damp the rotor stages, it is customary to arrange damping elements on them which absorb mechanical energy and thus have a damping effect. A further strategy is to avoid the occurrence of resonances by detuning the mechanical system.

In particular, it is common to use so-called damper rings, which can be arranged on a radially inner surface of a platform ring of the rotor disk.

WO 2020/178300 A1 discloses an aircraft turbomachine rotor with a damping device. The damping device comprises a support ring which extends transversely to a longitudinal axis and is attached to an outer circumference of a rotor disk of the aircraft turbomachine rotor. The damping device comprises a plurality of damping elements, which are connected to the supporting ring in a material fit and extend upstream from the supporting ring. The respective damping elements are arranged under at least one platform of a blade in order to exert a radially outwardly directed force in order to damp a radial displacement of the blade during the operation of the turbomachine.

EP 2 540 980 B1 discloses a damper for an integral blade rotor. The integral blade rotor comprises a divided ring damper which is mounted inside a circumferential groove and is in contact with a hub contact surface. The damper has a first limb and a second limb, wherein the first limb is in engagement with the circumferential groove and the second limb is in contact with the hub contact surface. An interface between the first limb and the second limb surrounds a radial lip of an inner hub surface.

U.S. Pat. No. 8,137,071 B2 discloses a shock absorber for impeller blades of a turboengine. The shock absorber is mounted between the lower side of the platforms of two adjacent rotor blades of a turboengine and the wheel rim of the rotor disk on which the rotor blades are mounted. The shock absorber comprises a balance weight, a base plate and a spring, wherein the spring connects the balance weight to the base plate. At least the balancing weight is made of a composite material and the base plate is adapted to rest on the wheel rim.

U.S. Pat. No. 10,138,756 B2 discloses a vibration damper for damping a gas turbine blade. The vibration damper comprises a plate and a counterweight. The plate is stamped from a metal sheet which is substantially thinner than the counterweight. The plate has a wall which is designed in such a way that it touches a platform of the blade of a wheel in a flexible manner while at least partially surrounding a surface of the counterweight.

DE 10 2018 203 093 A1 discloses a combination for sealing a gap between turbomachine blades and for reducing vibrations of turbomachine blades.

### SUMMARY

In an embodiment, the present disclosure provides a rotor device for a flow machine, comprising a rotor disk, wherein the rotor disk comprises at its outer circumference a blade platform ring on which a blade ring is arranged, and a damper. A flange arrangement, which extends in the circumferential direction, projects from a radially inner surface of the blade platform ring, forms a flange angle with the radially inner surface of the blade platform ring and has at least one passage opening. The damper has at least one damping element. The damping element has at least one holding part. A contact section of the holding part bears against the inner surface of the blade platform ring and a pass-through section of the holding part passes through the at least one passage opening of the flange arrangement.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a rotor device for a flow machine according to an embodiment of the present disclosure;

FIG. 2 shows a schematic representation of a damping element;

FIG. 3 shows a schematic representation of a damping element with a pulse regenerator;

FIG. 4 shows a schematic representation of a damping element on a rotor disk;

FIG. 5 and FIG. 6 show a schematic representation of a damping element comprising a pulse detuner;

FIG. 7 shows a schematic representation of an embodiment of the damping element with the pulse detuner;

FIG. 8 and FIG. 9 show a schematic representation of an embodiment of the damping element; and

FIG. 10 shows a schematic representation of an embodiment of the rotor device.

### DETAILED DESCRIPTION

In an embodiment, the present disclosure provides a damping element for a rotor device which reduces vibrations both by damping and by detuning.

The foregoing advantages are achieved by a rotor device for a flow machine, a rotor disk, and by a damping element according to embodiments of the present disclosure.

An aspect of the present disclosure relates to a rotor device for a flow machine. The flow machine can be, for example, a flow machine for an aircraft. The rotor device comprises a rotor disk, wherein the rotor disk comprises a blade platform ring on the outer circumference thereof. The blade platform ring is an annular blade ring platform. A blade ring is arranged on the blade platform ring. The rotor disk can also be designed as a rotor ring. In other words, it is provided that the rotor disk has an outer circumference on which the blade platform ring is arranged in the circumferential direction, this being an annular blade ring platform. The blade ring is arranged on the blade platform ring. The blade ring can comprise a plurality of blades which can be anchored by respective blade roots in openings of the blade ring platform. The blades can also be connected to the blade ring platform in a material-to-material manner, so that the rotor disk and the blade ring can be designed in a blisk or bling design. It is provided that a flange arrangement extends from a radially inner surface of the blade platform ring, said flange arrangement forming a flange angle with the radially inner surface of the blade platform ring and having at least one passage opening. The flange arrangement can extend in the circumferential direction on the radially inner surface and can project in the direction of a center of the rotor disk and thus be annular.

In other words, the blade platform ring has an inner surface, the normal of which can face the center of the rotor disk. The flange arrangement protrudes from the radially inner surface and likewise runs along the circumferential direction of the rotor disk. The flange angle is formed by the flange arrangement and the radially inner surface. The flange arrangement has the at least one passage opening. The passage opening can be a channel running along an axial direction of the rotor disk and running through the flange arrangement.

It is provided that the rotor device has a damping device. The damping device can have at least one damping element which is designed to damp vibrations of the rotor disk. It is provided that the damping element has at least one holding part, wherein a contact section of the holding part bears against the inner surface of the blade platform ring. The holding part can be designed as a holding plate or damping plate. The contact section can be a section of the holding part which can bear with a surface against the inner surface of the blade platform ring. The contact section can be planar or curved, wherein a curvature can have a radius which can correspond to a radius of the radially inner surface. In other words, the at least one holding part rests at its contact section on the inner surface of the blade platform ring. As a result, the holding part can be pressed against the inner surface of the blade platform ring, for example as a result of centrifugal forces occurring during operation of the flow machines. A pass-through section of the at least one holding part passes through the at least one passage opening of the flange arrangement. The pass-through section can be, for example, a tab which runs through the passage opening and engages around the flange arrangement at least in some regions. In other words, the pass-through section is arranged in the at least one passage opening of the flange arrangement. As a result, the holding part can be fixed in the passage opening on the flange arrangement by means of the pass-through section.

Embodiments of the present disclosure provide the advantage that the damping device can be arranged locally in a specific sector of the rotor disk.

An embodiment of the present disclosure provides that the contact section has a length between 1 and 30 mm. In other words, the contact section extends over a length of 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, or 30 mm. The length can relate, for example, to the region of the holding part which bears against the inner surface of the rotor disk and extends essentially in an axial direction of the rotor device. The contact section can be, for example, a region of a sheet-metal part which makes contact with the inner surface of the rotor disk. It is provided that the holding part has a thickness of between 0.1 mm and 3 mm. In other words, the thickness is 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm or 3.0 mm. The holding part can be, for example, a holding plate with a plate thickness between 0.1 mm and 3 mm. It is provided that the contact section and the pass-through section enclose a holding angle Φ between 45° and 90°. In other words, the contact section and the pass-through section are at a holding angle Φ of 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89 or 90° to each other. The holding part can be designed, for example, as a metal sheet, in which case at least one section of the pass-through section which adjoins the contact section can form the holding angle Φ with the contact section. For example, a corner or bend can be located between the contact section and the pass-through section. The holding angle Φ preferably corresponds to the flange angle, so that the contact section bears against the radially inner surface of the rotor disk and a section of the pass-through section adjoining the contact section bears against a surface of the flange arrangement.

An embodiment of the present disclosure provides that the holding part extends over a plurality of blade sectors. A respective one of the blade sectors can have exactly one respective blade. In other words, a respective blade is arranged in each blade sector of the rotor disk. A respective blade sector can be defined as a sector of the rotor disk, the circular arc of which has a blade base area of a respective blade. The holding part can be arranged in a plurality of the blade sectors.

An embodiment of the present disclosure provides that the damping device comprises a plurality of the damping elements, wherein a respective one of the damping elements is arranged in respective blade sectors of the rotor device, wherein each of the blade sectors has exactly one blade. In other words, a respective damping element is arranged in each blade sector of the rotor disk. A respective blade sector can be defined as a sector of the rotor disk, the circular arc of which has a base area of a respective blade. Preferably, a center of gravity of the respective damping element is arranged in a circumferential direction in a center of the respective blade sector.

An embodiment of the present disclosure provides that the damping device comprises a plurality of the damping elements, wherein the damping elements are arranged in respective intermediate sectors of the rotor device. A respective one of the intermediate sectors is arranged between two blade sectors of adjacent blades. In other words, a respective damping element is arranged in each intermediate sector of the rotor disk. Preferably, a center of gravity of the respective damping element is arranged in a circumferential direction in a center of the respective intermediate sector.

An embodiment of the present disclosure provides that the damping device has at least one damping element at an leading edge of the blade platform ring and/or the damping device has at least one damping element at an trailing edge of the blade platform ring. In other words, it is provided that at least one damping element is arranged on the radially inner surface, which is aligned in a direction of the leading edge of the blade platform ring. In addition or as an alternative to this, at least one damping element is arranged on the radially inner surface, which is oriented in a direction of the trailing edge of the blade platform ring. In other words, at least one of the damping elements is arranged on a side of the rotor device, which is oriented in an inflow direction, and/or at least one of the damping elements is arranged on a side of the rotor device, which is oriented in an outflow direction.

An embodiment of the present disclosure provides that the parameters of adjacent damping elements differ from one another. In other words, it is provided that the length of the contact section, the thickness and/or the holding angle of adjacent damping elements differ from one another. It can be provided, for example, that two sets of parameters are predetermined for the damping elements, the damping elements of the two sets of parameters being arranged alternately along a direction of rotation. This results in the advantage that A-B detuned blade rings can be damped. It can be provided that adjacent blades have different geometries in order to permit an A-B detuning. As a result, the blades can differ from one another in their resonance behavior. In order to permit damping of the respective resonances, the damping elements can be matched to the respective blades and likewise differ from one another.

An embodiment of the present disclosure provides that the damping element comprises at least one pulse detuner, wherein the pulse detuner encloses at least one cavity, wherein a respective ball having a predetermined ball mass is arranged in the cavity. The pulse detuner is designed to detune the rotor device. In other words, the damping element has the at least one pulse retarder, which is connected to the damping element in a force-fitting, form-fitting or material-fitting manner. The pulse detuner is designed to influence the resonance behavior of the rotor device by means of balls which are arranged in respective cavities and have a predetermined ball mass. The balls can detach from radially inner surfaces of the cavities, for example, due to a centrifugal force acting on them. The balls can be fastened to radially inner surfaces of the cavities in such a way that they detach at a predetermined frequency in the vicinity of a resonant frequency of the rotor device and thus influence the resonant behavior of the rotor device at least for a short time. For details of this detuning concept, reference is additionally made to WO 2012/095067 A1 and DE 10 2016 211 068 A1 and their content is expressly incorporated into the present disclosure. The advantage is that the damping element is designed to reduce vibrations of the rotor device both by damping and by detuning the rotor device.

An embodiment of the present disclosure provides that the pulse detuner comprises between 1 and 20 cavities with respective balls. In other words, the pulse detuner has up to 20 enclosed cavities, the respective ball being arranged in a respective one of the cavities. It is provided that the respective ball masses of the balls are between 0.1 grams and 3 grams. In other words, each of the balls has a ball mass of 0.1 gram, 0.2 gram, 0.3 gram, 0.4 gram, 0.5 gram, 0.6 gram, 0.7 gram, 0.8 gram, 0.9 gram, 1.0 gram, 1.1 gram, 1.2 gram, 1.3 gram, 1.4 gram, 1.5 gram, 1.6 gram, 1.7 gram, 1.8 gram, 1.9 gram, 2.0 gram, 2.1 gram, 2.2 gram, 2.3 gram, 2.4 gram, 2.5 gram, 2.6 gram, 2.7 gram, 2.8 gram, 2.9 gram or 3 gram. Between the balls and the side walls of the cavities there is a gap which is between 0.1 mm and 5 mm wide. In other words, the respectively nearest point of a sphere is arranged at a distance of 0.1 mm to 5 mm from the nearest side wall of the respective cavity. The side walls can be the walls of the hollow space which are aligned parallel to an intended direction of movement of the balls and perpendicular to the radially inner surfaces of the hollow chambers.

An embodiment of the present disclosure provides that the at least one damping element comprises at least one compensating element which bears with a first lateral surface against the contact section of the holding part and bears with a second lateral surface, opposite the first lateral surface, against the at least one pulse detuner. The compensating element has a compensating angle which is arranged opposite the second lateral surface. In other words, the first lateral surface of the compensating element can be arranged on the contact section. The compensating element can comprise, for example, a metal sheet or a filling compound. The compensating element can have the second lateral surface, which can be arranged at the compensating angle to the first lateral surface. The pulse detuner can be arranged on the second lateral surface. The compensating angle preferably corresponds to the flange angle and/or the holding angle. The advantage is that the damping element can be oriented at a predetermined angle to the radially inner surface. It can be provided, for example, that the flange angle and the holding angle are each 45°. It can be provided that the pulse detuner is to be aligned with a surface normal in a radial direction so that the centrifugal force acts on the balls in a longitudinal direction of the cavities. By providing the compensating element with the compensating angle of 45°, the flange angle and the holding angle can be compensated, so that the pulse detuner is aligned with a surface normal parallel to the radial direction of the rotor disk.

An embodiment of the present disclosure provides that the damping element comprises a plurality of the pulse detuners, wherein a respective one of the pulse detuners is arranged in respective blade sectors of the rotor device and/or respective intermediate sectors of the rotor device. In other words, a respective pulse detuner is arranged in each blade sector or in each of the intermediate sectors of the rotor disk. Preferably, a center of gravity of the respective pulse detuner is arranged in a center of the respective blade sector or of the respective intermediate sector. It can be provided, for example, that the at least one damping element extends over a plurality of the blade sectors and/or intermediate sectors. It can be provided, for example, that the contact section of the holding part runs through a plurality of the blade sectors and/or intermediate sectors. The pulse detuners can be arranged on the contact section or on the compensating element.

An embodiment of the present disclosure provides that the holding part closes off at least one of the cavities. In other words, it is provided that the holding part is arranged on the pulse detuner in such a way that it closes at least one of the cavities. The holding part can, for example, form a cover of at least one of the cavities. The holding part can be as disclosed in DE 10 2016 211 068 A1, in which case the holding part can comprise the second subregion described in DE 10 2016 211 068 A1 and/or the third subregion.

An embodiment of the present disclosure provides that the parameters of adjacent pulse detuners differ from one another. It can be provided, for example, that two sets of parameters are predetermined for the pulse detuners, the pulse detuners of the two sets of parameters being arranged alternately along a direction of rotation. This results in the advantage that A-B detuned blade rings can be detuned. It can therefore be provided that adjacent blades have different geometries in order to permit an A-B detuning. As a result, the blades can differ from one another in their resonance behavior. In order to make possible a detuning of the respective resonances, the pulse detuners can be matched to the respective blades and likewise differ from one another. This makes it possible to prevent resonant frequencies from being reached in the respective blades. For example, the number of cavities, the ball masses and/or the size of the gaps between the balls and the side walls of the cavities can differ from one another.

An aspect of the present disclosure relates to a rotor disk. The outer circumference of the rotor disk comprises a blade platform ring on which a blade ring is arranged. On a radially inner surface of the blade platform ring there is a flange arrangement which extends in the circumferential direction and forms a flange angle with the radially inner surface of the blade platform ring and has at least one passage opening.

The features presented in connection with the rotor device according to an aspect of the present disclosure and their advantages apply correspondingly to the rotor disk according to the present disclosure and vice versa.

An aspect of the present disclosure relates to a damping device. The damping device comprises at least one damping element, which comprises at least one holding part, wherein the holding part has a contact section, which is provided for arrangement on a radially inner surface of the blade platform ring. The holding part has a pass-through section which is provided for arrangement in at least one passage opening of a flange arrangement.

The features presented in connection with the rotor device according to aspects of the present disclosure and their advantages apply correspondingly to the damping device according to the present disclosure and vice versa.

Further features of the present disclosure will become apparent from the exemplary embodiments. The features and combinations of features mentioned above in the description, and the features and combinations of features mentioned below in the description of the figures and/or shown alone in the figures, can be used not only in the combination indicated in each case, but also in other combinations, without departing from the scope of the present disclosure. Embodiments of the present disclosure which are not explicitly shown and explained in the figures but which emerge from the explained embodiments and can be produced by separate combinations of features are thus also to be regarded as encompassed and disclosed.

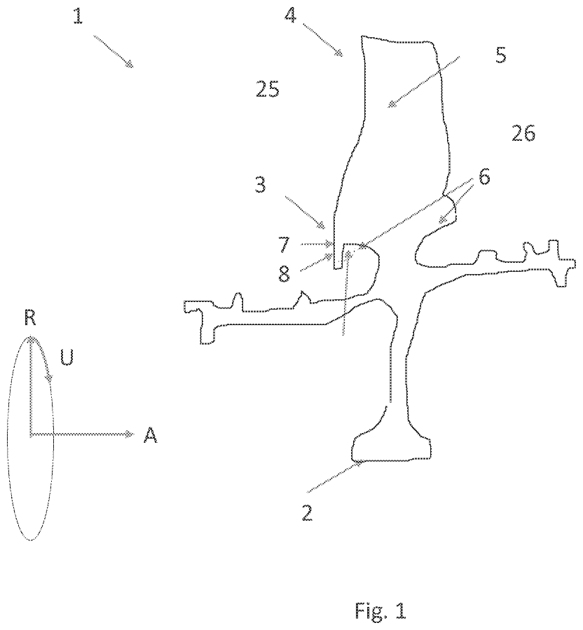

FIG. 1 shows a schematic representation of a rotor device 1 for a flow machine. The flow machine can be, for example, a power unit of an aircraft. The rotor device 1 can be provided, for example, for a rotor stage of a compressor or a turbine of the flow machine. The rotor device 1 can comprise a rotor disk 2 which can also be designed as a rotor ring. On an outer circumference of the rotor disk 2, the rotor disk 2 can have an annular blade ring platform 3. Blades 5 of a blade ring 4 can be arranged on the blade ring platform 3. These can be connected to the rotor disk 2, for example, via dovetail connections. The blades 5 can also be connected to the rotor disk 2 in a material-locking manner. In this case, the rotor disk 2 can be designed as a ring or blisk. During operation of the rotor device 1, vibrations can occur in the rotor disk 2 and/or the blades 5 of the blade ring 4. In particular in the integrated embodiments, the vibrations can lead to a dynamic loading of the rotor disk 2 and/or of the blade ring 4 due to a lack of damping at the material connection of the blades 5 with the rotor disk 2. In order to be able to provide mechanical damping, in particular for an integrated embodiment of the rotor disk 2, provision can be made for damping elements 10 of a damping device 9 of the rotor device 1 to be arranged on the rotor device 1. In order to permit an arrangement of the damping elements 10 on the rotor disk 2, the rotor disk 2 can have a flange arrangement 7 which extends along a circumferential direction U of the rotor disk 2 and can project from the blade platform ring 3 in a direction towards a center of the rotor disk 2. The flange arrangement 7 and a radially inner surface 6 of the blade platform ring 3 can enclose a flange angle θ which can be, for example, 45° to 90°. For fastening the damping elements 10, the flange arrangement 7 can have passage openings 8 which can be formed, for example, by respective tunnels extending in an axial direction A in the flange arrangement 7. The flange arrangement 7 can be arranged in the axial direction of an leading edge 25 and/or an trailing edge 26 of the rotor device 1.

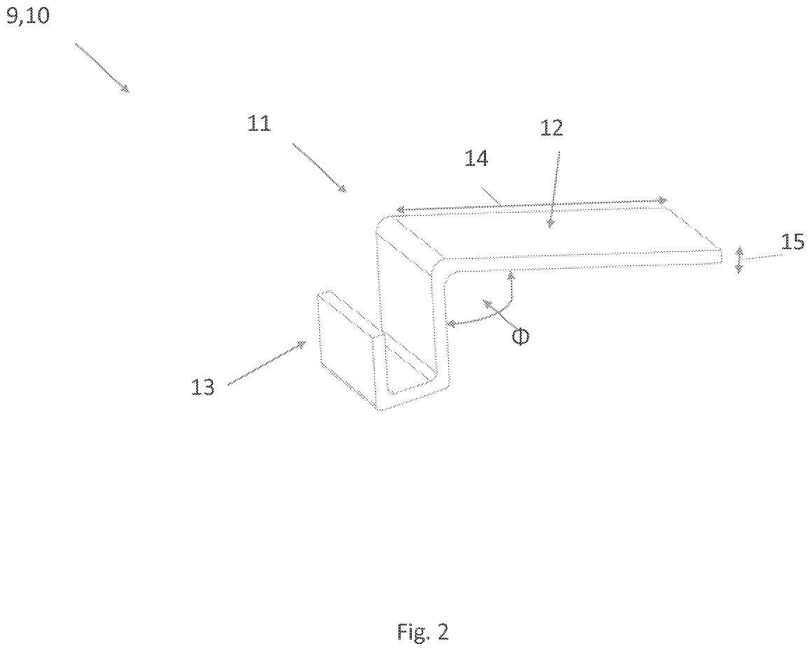

FIG. 2 shows a schematic representation of a damping element. The damping element 10 can be made, for example, at least in sections from a metal sheet and have a thickness 15 of between 0.1 mm and 3 mm. The holding part 11 can have a contact section 12 which can be provided for the purpose of completely or at least partially contacting the radially inner surface 6 of the blade platform ring 3. The holding part 11 can be, for example, curved in the contact section 12. The holding part 11 can have a pass-through section 13 which can be provided for producing a mechanical connection to the blade platform ring 3 by arranging at least one region of the through-section 13 in the passage opening 8 of the blade platform ring 3. In this case, the pass-through section 13 can be shaped in its profile as a hook which can engage around a region of the flange arrangement 7. The pass-through section 13 can be designed as a tab or hook. A section of the pass-through section 13, which can be provided for resting against a surface of the flange arrangement 7, can be separated from the contact section 12 by a corner or a rounding. The section of the contact section 12 and the pass-through section 13 can enclose a holding angle Φ. This can be, for example, 45° to 90° and correspond to the flange angle θ.

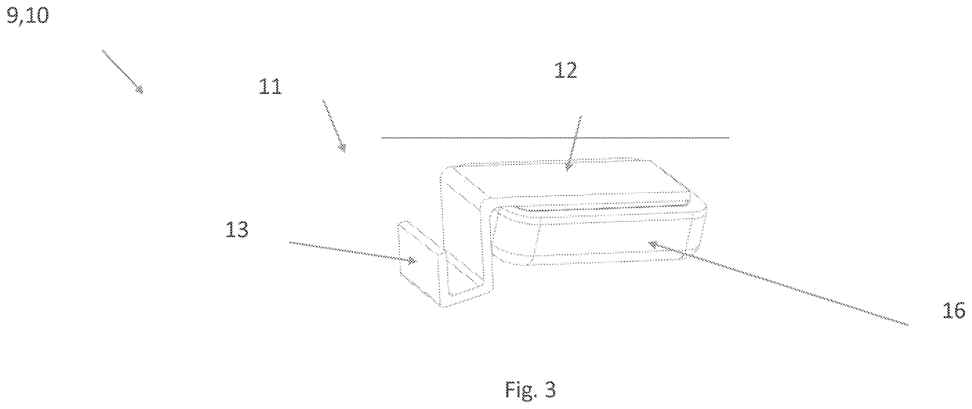

FIG. 3 shows a schematic representation of a damping element with a pulse detuner 16. The pulse detuner 16 can be provided for influencing a resonant frequency of the rotor device 1 in order to thus avoid the occurrence of resonances. The pulse detuner 16 can have one or more cavities 17 in which respective balls 18 can be arranged. The pulse detuner 16 can have, for example, 1 to 20 hollow chambers. The cavities 17 can be bounded by side walls 21 and end walls. The pulse detuner 16 can be arranged on the holding part 11. The holding part 11 can also be a cover for closing at least one of the cavities 17. The advantage of arranging the pulse detuning devices 16 on the damping element 10 is that the damping element 10 acts both as a detuning device and as a damping device. As a result, vibrations are reduced in two ways by the damping element 10.

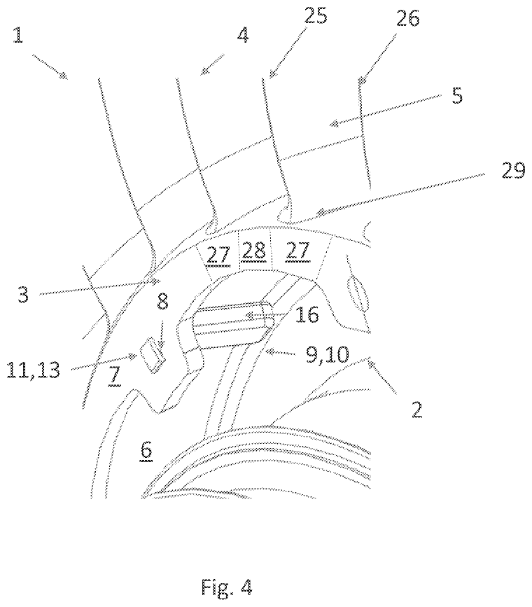

FIG. 4 shows a schematic representation of a damping element on a rotor disk 2. The pass-through section 13 of the damping element 10 can be arranged in the passage opening 8 of the flange arrangement 7. The pass-through section 13 can engage in the flange arrangement 7 and thereby hold the damping element 10 on the flange arrangement 7. The pulse detuner 16 can be arranged on the contact section 12 of the holding part 11. The holding angle Φ, which can be, for example, between 45 and 90°, can be limited between the section of the pass-through section 13 and the contact section 12. The holding angle Φ can be identical in magnitude to the flange angle Θ. The holding angle Φ can also be designed to be larger than the flange angle Θ and can be reduced during installation, as a result of which the holding part 11 can act resiliently and can press the contact section 12 against the radially inner surface 6.

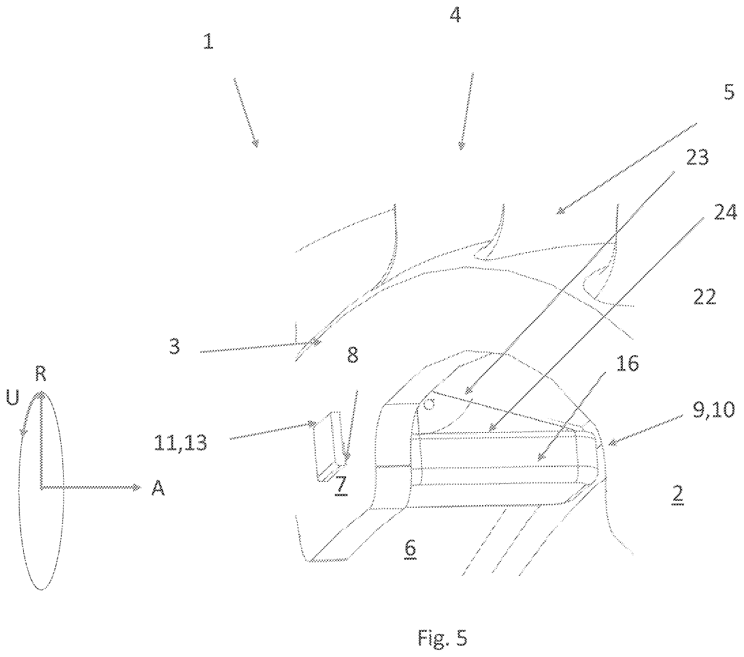

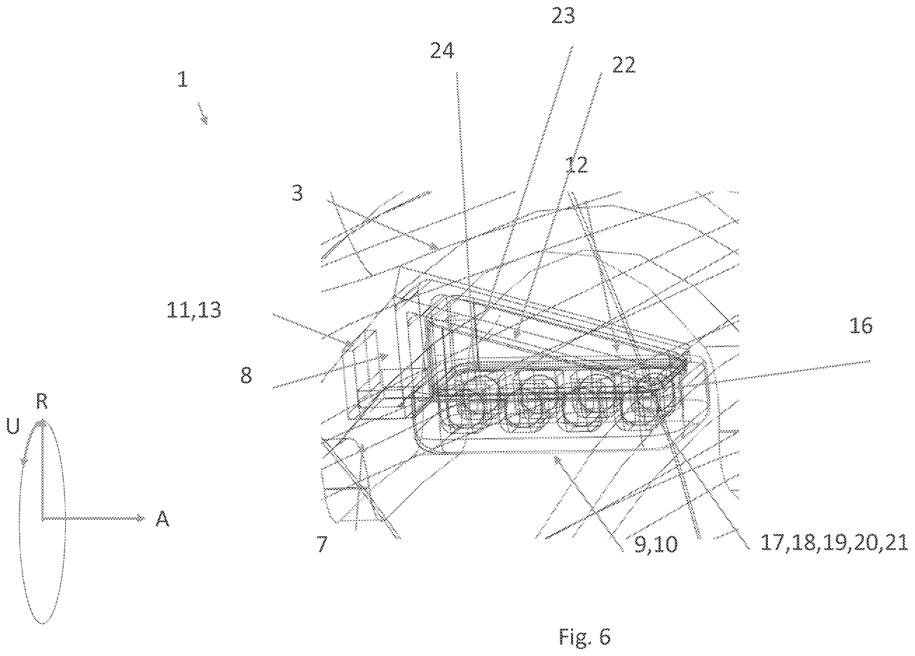

FIGS. 5 and 6 show a schematic representation of a damping element 10, comprising a pulse detuner 16. The damping element 10 can have a compensating element 22 which can be arranged on the holding part 11. The compensating element 22 can, for example, be wedge-shaped and rest with a first lateral surface 23 against the contact section 12 of the holding part 11 and with a second lateral surface 24 against the pulse detuner 16. The first lateral surface 23 and the second lateral surface 24 can converge. A compensating angle σ of the compensating element 22, which can lie opposite the second lateral surface 24, can be selected as a function of the flange angle Θ and/or the holding angle Φ, so that a contact face 30 of the pulse detuner 16 can be aligned with its normal parallel to a radial direction R of the rotor disk 2.

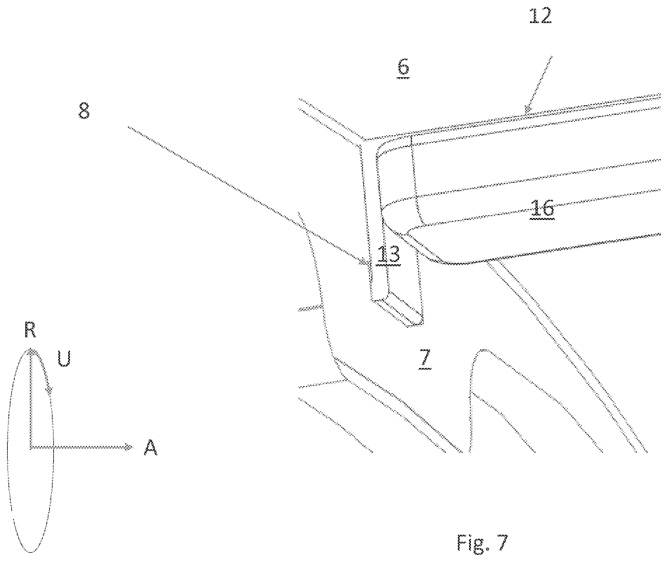

FIG. 7 shows a schematic representation of an embodiment of the damping element 10 with the pulse detuner. The radially inner surface 6 can be aligned with its normal in a radial direction R of the rotor disk 2. The flange angle θ and the holding angle φ can be 90°. During operation, the centrifugal force acts along the radial direction R, which can be aligned along a longitudinal direction of the cavities 17. A compensating element 22 for changing the alignment of the pulse detuner 16 is thus not required.

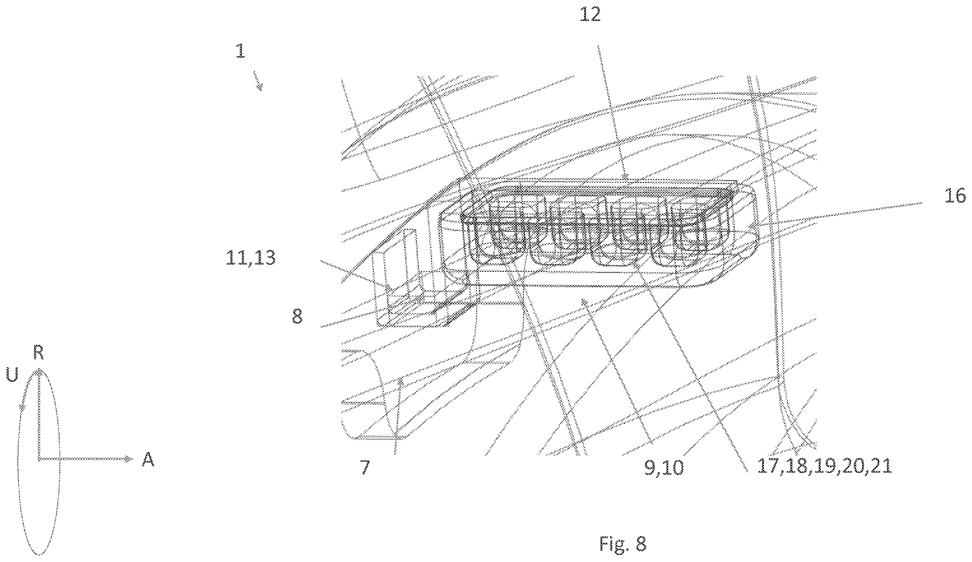

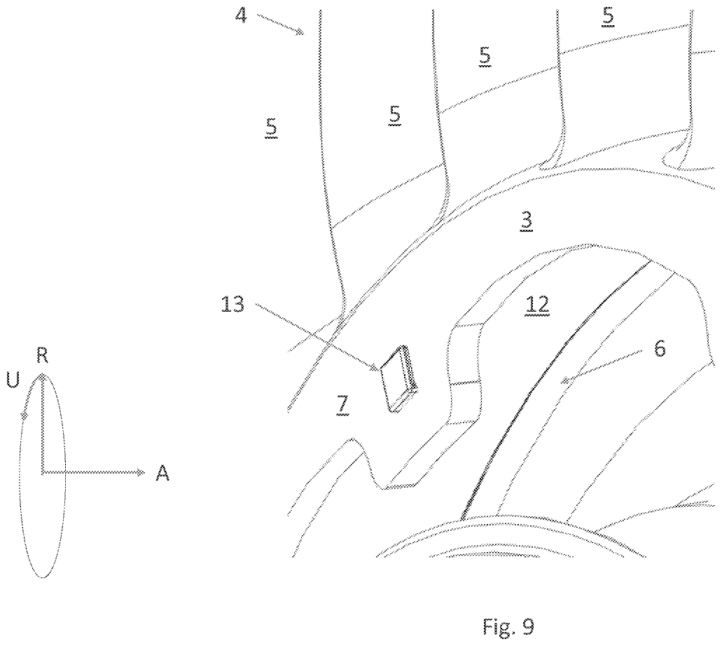

FIG. 8 and FIG. 9 show a schematic representation of an embodiment of the damping element. The damping element 10 can have the holding part 11 which has the pass-through section 13 of the holding part 11 and the contact section 12. The contact section 12 can be designed to extend over a sector of the radially inner surface 6 of the blade platform ring 3, which can extend over a plurality of blade sectors 27 and/or intermediate sectors 28. The vane sectors 27 can describe respective sectors of the rotor disk 2 which can be bounded by base surfaces 29 of the respective vanes 5 in the direction of rotation U

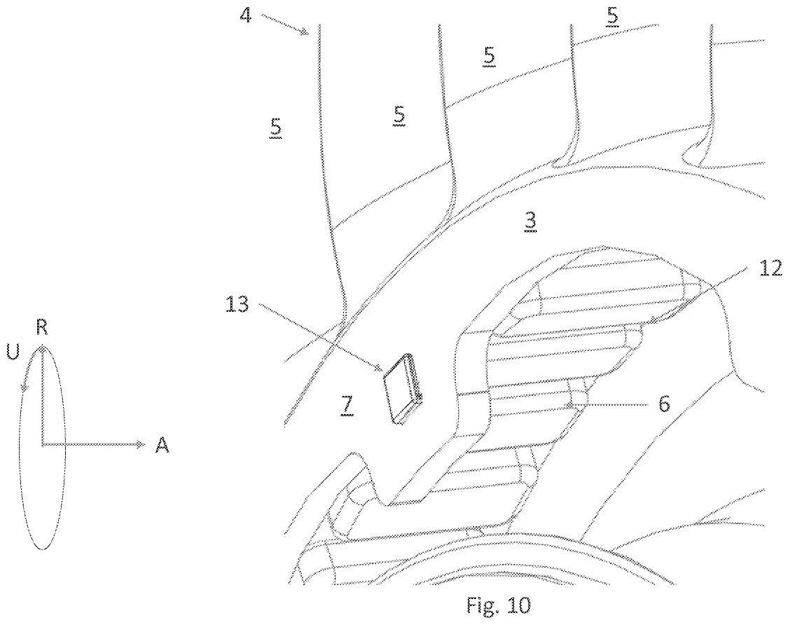

FIG. 10 shows a schematic representation of the rotor device. The damping element 10 can include the holding part 11 as shown in FIG. 9, which can extend over a plurality of blade sectors 27 and/or intermediate sectors 28. The damping element 10 can have a plurality of the pulse detuners 16 which can be arranged on the holding part 11. It can be provided that respective pulse detuners 16 can be arranged in respective blade sectors 27 and/or in the respective intermediate sectors 28. It can be provided that the pulse detuners 16 of adjacent blades 5 differ from one another. This can be provided if the blades 5 of the blade ring 4 are A-B detuned.

It is generally known that the blades 5 of an engine can be caused to vibrate due to a plurality of different, mainly aerodynamic, conditions. In the blisk construction, in which the blades 5 are manufactured integrally with the supporting ring, undesired vibrations can occur to an increased extent, because the mechanical damping of the system is very low. Particularly in the case of oscillation forms and/or oscillation frequencies with low positive or even negative aerodynamic damping, which is referred to as fluttering, this can lead to higher oscillation voltages and thus insufficient service life or even rapid failure.

Damping devices 9 are provided which can be designed as individual/multiple metal sheets with tabs, also in combination with pulse detuners 16. Essential features can be:
Positions below trailing edge 26 and/or leading edge 25
Positions under each blade 5 or between each pair of blades
In the case of A-B detuning of the blade ring 4, different dampers and/or different pulse detuners 16 can be arranged under the A-blades 5 and the B-blades 5.

A placement of the pulse detuners 16 and/or of the damping elements 10 on blade sectors 27 of individual blades 5 can be limited. These particularly vibration-critical blades 5 can be identified beforehand by tests in a mistuning test stand. The holding element can be designed as damper plates with the following parameters:
Length 14 between 1 and 30 mm
Height 15 Between 0.1 and 3mm
Holding angle Φ between 45° and 90°, alternatively: support angle sheet metal BLISK between 0° and 45°.

In the case of the combination with pulse detuners 16, the ball masses 19 are between 0.1 and 3 grams, the gaps ball 18 cavity wall is between 0.1 and 5 mm, and the number of balls 18 is between 1 and 20.

Important individual cases:
Sheet metal bracket 90° support bracket 0°
Sheet metal at the same time lid of the pulse detuning box
Wide metal sheet under several blades 5 on a tab. This can be designed with or without pulse detuners 16.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE LIST:

1 rotor device
2 rotor disk
3 blade platform ring
4 blade ring
5 blade
6 inside surface
7 flange arrangement
8 passage opening
9 damping device
10 damping element
11 holding part
12 contact section
13 pass-through section
14 length
15 thickness
16 pulse detuner
17 cavity
18 ball
19 ball mass
20 gap
21 side panel
22 compensating element
23 first lateral surface
24 second lateral surface
25 leading edge
26 trailing edge
27 blade sectors
28 intermediate sector
29 base surface
30 contact area
31 weld
32 curvature
33 blade base
34 pocket
U circumferential direction
A axial direction
R radial direction
Θ flange angle
Φ holding angle
σ compensation angle
α first contact angle
β second contact angle

1. A rotor device for a flow machine, comprising:
a rotor disk, wherein the rotor disk comprises at its outer circumference a blade platform ring on which a blade ring is arranged,
wherein a flange arrangement, which extends in the circumferential direction, projects from a radially inner surface of the blade platform ring, forms a flange angle with the radially inner surface of the blade platform ring and has at least one passage opening; and
a damper,
wherein the damper has at least one damping element,
wherein the damping element has at least one holding part,
wherein a contact section of the holding part bears against the inner surface of the blade platform ring and a pass-through section of the holding part passes through the at least one passage opening of the flange arrangement.

2. The rotor device according to claim 1, wherein the contact section has a length of between 1 and 30 mm,
wherein the holding part has a thickness of between 0.1 and 3 mm, and
wherein the contact section and the pass-through section enclose a holding angle of between 45° and 90°.

3. The rotor device according to claim 1, wherein the holding part extends over a plurality of blade sectors.

4. The rotor device as claimed in claim 1, wherein the at least one damping element comprises a plurality of damping elements,
wherein a respective one of the damping elements is arranged in respective blade sectors of the rotor device, and
wherein each of the blade sectors has exactly one blade.

5. The rotor device according to claim 1, wherein the at least one damping element comprises a plurality of damping elements, a respective one of the damping elements being arranged in respective intermediate sectors of the rotor device, each of the intermediate sectors being arranged between two blade sectors of adjacent blades.

6. The rotor device according to claim 1, wherein the damper has at least one damping element on a leading edge of the blade platform ring and/or wherein the damper has at least one damping element on a trailing edge of the blade platform ring.

7. The rotor device according to claim 2, wherein lengths, contact sections, thicknesses of the holding parts and/or holding angles of adjacent damping elements of the at least one damping elements differ from one another.

8. The rotor device according to claim 1, wherein at least one of the at least one damping elements comprises at least one pulse detuner,
wherein the at least one pulse detuner encloses at least one cavity, and
wherein a respective ball having a predetermined ball mass is arranged in the at least one cavity.

9. The rotor device according to claim 8, wherein the at least one pulse detuner comprises between 1 and 20 cavities with respective balls,
wherein respective ball masses of the balls are between 0.1 and 3 grams, and
wherein gaps between the balls and side walls of the cavities are between 0.1 and 5 mm.

10. The rotor device according to claim 8, wherein the at least one damping element comprises at least one compensating element, which rests with a first lateral surface against the contact section of the holding part, and rests with a second lateral surface, which is located opposite the first lateral surface, against the at least one pulse detuner, wherein the first and second lateral surfaces converge and the first lateral surface and the flange arrangement form a compensating angle.

11. The rotor device according to claim 8, wherein the damper comprises a plurality of pulse detuners, wherein a respective one of the pulse detuners is arranged in a respective blade sector of the rotor device and/or a respective intermediate sectors of the rotor device.

12. The rotor device according to claim 8, wherein the holding part closes off at least one of the at least one cavities of the at least one pulse detuners.

13. The rotor device according to claim 8, wherein a number of the at least one cavities, the ball masses and/or the gaps of adjacent pulse detuners differ from one another.

14. A rotor disk for therotor device according to claim 1, the rotor disk comprising an annular blade ring platform on which a blade ring is arranged, the annular blade ring platform being arranged on an outer circumference of the rotor disk, a flange arrangement extending in the circumferential direction projecting from a radially inner surface of the blade platform ring, the flange arrangement forming a flange angle with the radially inner surface of the blade platform ring and having at least one passage opening.

15. A damper for the rotor device according to claim 1, comprising at least one damping element, wherein the at least one damping element has at least one holding part, wherein a contact section of the holding part is configured to be arranged on an inner surface of a blade platform ring, and a pass-through section of the holding part is configured to pass through at least one passage opening of a flange arrangement.
